(19) United States
(12) Patent Application Publication
(10) Pub. No.: US 2020/0268230 A1
(43) Pub. Date: Aug. 27, 2020

(54) Sponge Product

(71) Applicants: Clinton D. Bunch, Keller, TX (US); Joshua A. Bunch, Keller, TX (US)

(72) Inventors: Clinton D. Bunch, Keller, TX (US); Joshua A. Bunch, Keller, TX (US)

(21) Appl. No.: 16/752,392

(22) Filed: Jan. 24, 2020

Related U.S. Application Data
(60) Provisional application No. 62/836,893, filed on Apr. 22, 2019.
(60) Provisional application No. 62/796,726, filed on Jan. 25, 2019.

(51) Int. Cl. A47L 17/08; A47L 13/16; B32B 5/18; B32B 5/32; B32B 7/022

(52) U.S. Cl. CPC A47L 17/08; A47L 13/16; B32B 5/18; B32B 2307/726; B32B 7/022; B32B 2307/538; B32B 5/32

(57) ABSTRACT

A sponge product for cleaning a work surface is disclosed. In one embodiment, a foraminous body layer is attached to an abrasive body layer. A microfiber textile surrounds the foraminous body layer and the abrasive body layer. The foraminous body layer, the abrasive body layer, and the microfiber textile form a unitary product. An exterior of the microfiber textile includes a side having a visual indicator proximate to the foraminous body layer and another side having another visual indicator proximate the abrasive body layer. The two visual indicators are different and may be different colors, for example. One side of the sponge product has a greater water absorption characteristic than the other side.

### PRIORITY STATEMENT & CROSS-REFERENCE TO RELATED APPLICATIONS

This application claims priority from (1) co-pending U.S. Patent Application Ser. No. 62/836,893 entitled “Sponge Product” filed on Apr. 22, 2019, in the names of Clinton D. Bunch et al.; and (2) co-pending U.S. Patent Application Ser. No. 62/796,726 entitled “Sponge Product” and filed on Jan. 25, 2019, in the names of Clinton D. Bunch et al.; both of which are hereby incorporated by reference, in entirety, for all purposes.

### TECHNICAL FIELD OF THE INVENTION

This invention relates, in general, to cloths, pads, and sponges and, in particular, to a sponge product that is capable of absorbing liquids inside the sponge product as well as wiping surfaces.

### BACKGROUND OF THE INVENTION

Sponges typically have an absorbent portion made from a synthetic or plant material capable of absorbing liquids inside the sponge. Sponges are able to absorb liquids, nonetheless have poor wiping properties, and can leave behind traces of water on the surfaces treated. On the other hand, cleaning cloths made from woven microfibers provide improved wiping properties, while being relatively thin and capable of fraying. Improvements in cloths, pads and sponges are needed.

### SUMMARY OF THE INVENTION

It would be advantageous to achieve a sponge product that would improve upon existing limitations in functionality with respect to water absorption and wiping. It would also be desirable to enable a mechanical and materials science-based solution that would provide enhanced performance and improved usability. To better address one or more of these concerns, a sponge product for cleaning a work surface is disclosed. In one embodiment, a foraminous body layer is attached to an abrasive body layer. A microfiber textile surrounds the foraminous body layer and the abrasive body layer. The foraminous body layer, the abrasive body layer, and the microfiber textile form a unitary product. An exterior surface of the microfiber textile includes a first side with a first visual indicator proximate to the foraminous body layer and a second side with a second visual indicator proximate the abrasive body layer. The first visual indicator and second visual indicator are different and may be different colors, for example. The first side of the sponge product has a greater water absorption characteristic than the second side. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a front top perspective view illustrating one embodiment of a sponge product according to the teachings presented herein;

FIG. 2 is a rear bottom perspective view of the sponge product depicted in FIG. 1;

FIG. 3 is a front top perspective view, in partial cross-section, of the sponge product depicted in FIG. 1;

FIG. 4 is a front top perspective view illustrating the sponge product depicted in FIG. 1 in one operational embodiment;

FIG. 5 is a front top perspective view illustrating the sponge product depicted in FIG. 4 in another operational embodiment;

FIG. 6 is a front top perspective view illustrating an alternative embodiment of a sponge product, according to the teachings presented herein, in one operational embodiment;

FIG. 7 is a front top perspective view illustrating the sponge product depicted in FIG. 6 in another operational embodiment;

FIG. 8 is a front top perspective view illustrating a still further embodiment of a sponge product, according to the teachings presented herein;

FIG. 9 is a rear bottom perspective view of the sponge product depicted in FIG. 8;

FIG. 10 is a front top perspective view illustrating the sponge product depicted in FIG. 8 in one operational embodiment; and

FIG. 11 is a front top perspective view illustrating the sponge product depicted in FIG. 8 in another operational embodiment.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

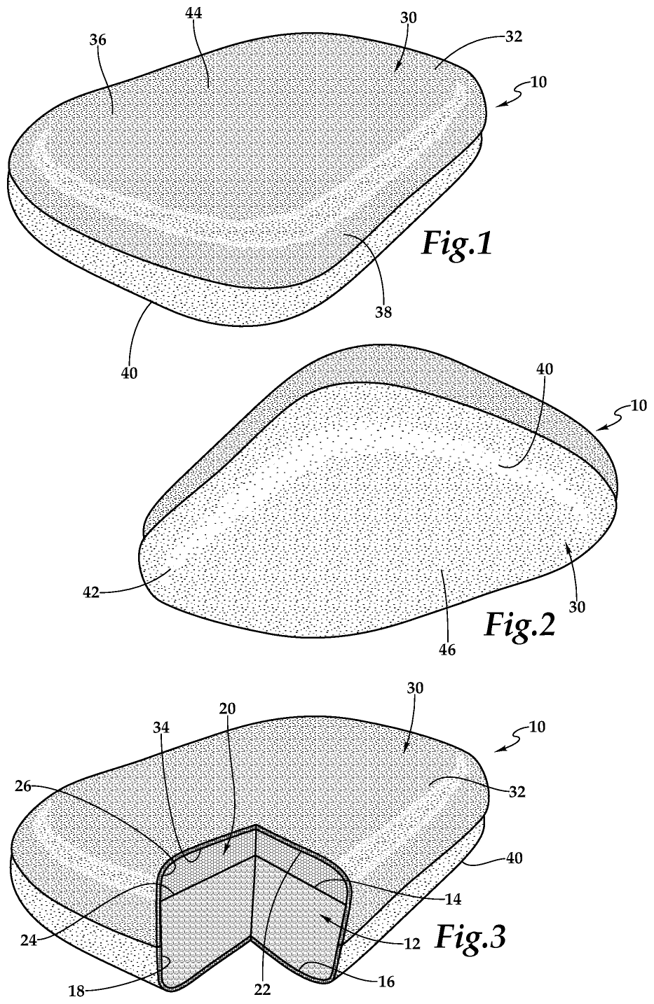

Referring initially to FIG. 1, FIG. 2, and FIG. 3, therein is depicted one embodiment of a sponge product, which is schematically illustrated and designated 10. In one embodiment, the sponge product 10 includes a foraminous body layer 12 having an upper surface 14, a lower surface 16, and a sidewall 18 joining the upper surface 14 to the lower surface 16. As shown, the upper surface 14 and the lower surface 16 may be located in opposed, parallel spaced relation. An abrasive body layer 20 may include a top surface 22, a bottom surface 24, and a side surface 26 joining the top surface 22 and the bottom surface 24. As shown, the top surface 22 and the bottom surface 24 may be located in opposed, parallel spaced relation.

In the illustrated embodiment, the upper surface 14 of the foraminous body layer 12 is attached to the bottom surface 24 of the abrasive body layer 20. A microfiber textile 30 includes an exterior surface 32 and an interior surface 34. The interior surface 34 surrounds the foraminous body layer 12 and the abrasive body layer 20. On the other hand, the exterior surface 32 includes a side 36 with a visual indicator 38 proximate to the abrasive body layer 20. The exterior surface 32 also includes a side surface 40 with a visual indicator 42 proximate the foraminous body layer 12. As shown in the illustrated embodiment, the foraminous body layer 12, the abrasive body layer 20, and the microfiber textile 30 form a unitary product, i.e., the sponge product 10.

Each of the visual indicators 38, 42 may include a color, symbol, icon, letters, or the like, including combinations thereof. In one embodiment, the visual indicator 38 and the visual indicator 42 are different. In one particular embodiment, the visual indicator 38 and the visual indicator 42 are different colors, color 44 and color 46. The foraminous body layer 12 and the abrasive body layer 20 may have different water absorption characteristics. In one embodiment, the foraminous body layer 12 is capable of absorbing more water than the abrasive body layer 20. Therefore, the side surface 40 of the sponge product 10 proximate to the foraminous body layer 12 has a greater water absorption characteristic than the side surface 36 proximate to the abrasive body layer 20. On the other hand, the foraminous body layer 12 and the abrasive body layer 20 may have different scrubbing characteristics. In one embodiment, the abrasive body layer 20 is capable of providing greater wear on other components, such as grout, than the foraminous body layer 12. Therefore, the side surface 36 of the sponge product 10 proximate to the abrasive body layer 20 has a greater scrubbing characteristic than the side surface 40 of the sponge product 10 proximate to the foraminous body layer 12.

In one embodiment, the foraminous body layer 12 may be a sponge-type portion including a polyurethane foam and, more particularly, an open-celled hydrophilic, polyurethane foam. Polyester polyol-based polyurethane foams are particularly useful. Typically, these foams utilize suitable polyester polyols such as those produced by reacting a dicarboxylic and/or monocarboxylic acid with an excess of a diol and/or polyhydroxy alcohol, for example, adipic acid, glutaric acid, succinic acid, phthalic acid or anhydride, and/or fatty acids (linolic acid, oleic acid and the like) with diethylene glycol, ethylene glycol, propylene glycol, dipropylene glycol, 1,4-butanediol, neopentyl glycol, trimethylolpropane, trimethylolethane, and/or pentaerythritol. Examples of these polyols are LEXOREZ 1102-50 or LEXOREZ 1102-60 from Inolex Chemical Company or FOMREZ 50 or FOMREZ 60 from Crompton Corporation. Other suitable polyester polyols can be prepared by reacting a lactone with an excess of a diol such as caprolactone with propylene glycol.

The polyester polyurethane foams are prepared using any suitable organic polyisocyanates well known in the art including, for example, hexamethylene diisocyanate, phenylene diisocyanate, toluene diisocyanate (TDI) and 4,4′-diphenylmethane diisocyanate (MDI). The methylene diisocyanates suitable for use are diphenyl methane diisocyanate and polymethylene polyphenyl isocyanate blends (sometimes referred to as “MDI” or “polymeric MDI”). The MDI blends can contain diphenylmethane 4,4′ diisocyanate, as well as 2,2′- and 2,4′-isomers and higher molecular weight oligomers and have an isocyanate functionality of from about 2.1 to about 2.7, preferably from about 2.1 to about 2.5. Preferably, the isocyanate is selected from a commercial mixture of 2,4- and 2,6-toluene diisocyanate. A well-known commercial toluene diisocyanate is TD80, a blend of 80% 24-toluene diisocyanate and 20% 26-toluene diisocyanate. Polyisocyanates are typically used at a level of between 20 and 90 parts by weight per 100 parts of polyol, depending upon the polyol OH content and water content of the formulation.

In practicing the teachings presented herein, it should be appreciated that with respect to the foraminous body layer 12, a particularly preferred polyurethane foam to be used herein is that which is sold by Armaly Brand Products under the trademark PROPLUS. PROPLUS sponges include a synthetic polyurethane foam which does not support bacterial growth thereby providing a longer useful life for the product.

In one embodiment, the abrasive body layer 20 may be a reticulated foam product. Such reticulated foam products are well known and commercially available. Generally, they comprise of a reticulated polyurethane foam. In preparing such reticulated abrasive foams, typically, a slow melt is carried out in the presence of a suitable reticulating agents such as dimethylsulfoxide, dimethylacetamide, formamide, dimethylformamide, II-pyrrolidone and I-methyl II-pyrrolidone. These reticulating agents cause a controlled melting of the sponge material during the freeze drying process.

In practicing the teachings presented herein, it should be appreciated that with respect to the abrasive body layer 20, a particularly preferred reticulated polyurethane foam to be used herein is that which is sold by Armaly Brand Products under the trademark BRILLO® ESTRACELL®. BRILLO® ESTRACELL® scrub sponges include a synthetic reticulated polyurethane foam which does not support bacterial growth, thereby providing a longer useful life for the product.

It should be further noted that in practicing the teachings presented herein, the foraminous body layer 12 and the abrasive body layer 20 may be adhered theretogether by flame laminating, extrusion or with a suitable adhesive, for example. The microfiber textile 30 may be a synthetic fiber finer than one denier or decitex/thread, having a diameter of less than ten micrometers. Microfiber textiles may be made from polyesters, polyamides (e.g., nylon, Kevlar, Nomex, trogamide), or a conjugation of polyester, polyamide, and polypropylene.

In practicing the teachings presented herein, it should be appreciated that with respect to the microfiber textile 30, a particularly preferred material to be used herein is that which is sold by Photodon Brand Products under the product name Microfiber Cleaning Cloth. Such microfiber cleaning cloths include a synthetic polyester and nylon (poliamide) blend which does not support bacterial growth thereby providing a longer useful life for the product.

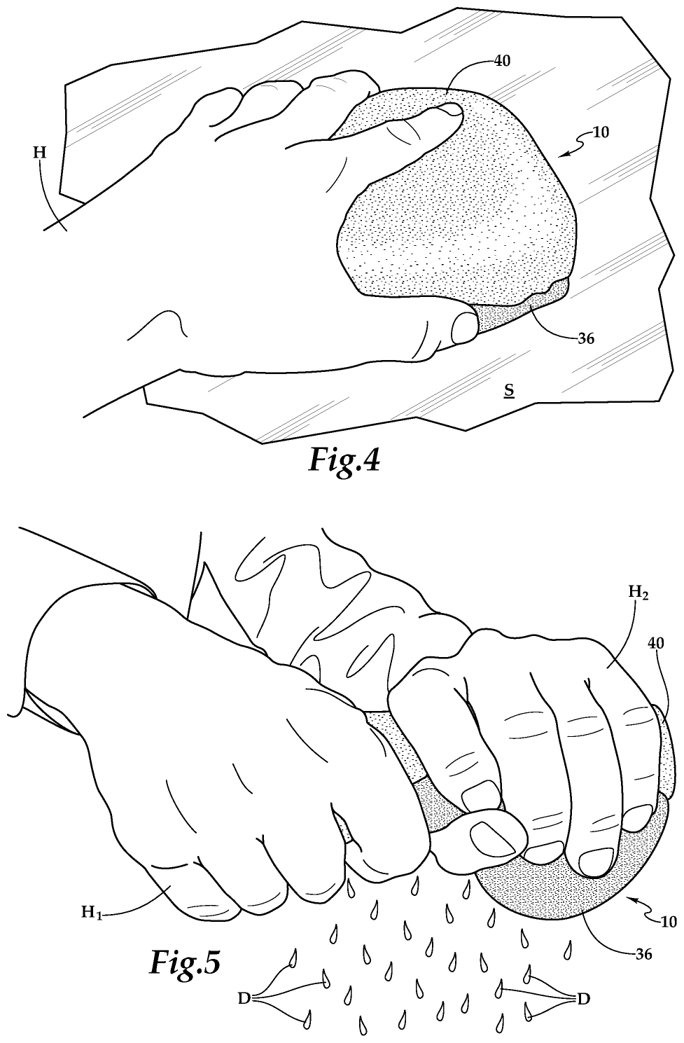

Referring now to FIG. 4 and FIG. 5, as shown, the sponge product 10 includes a dimension sized for hand span (hand H in FIG. 4) and a configuration sized for two-handed wringing (hands H₁ and H₂ in FIG. 5). The sponge product 10 described hereinabove provides the user with a multi-surface sponge product 10 having a low profile shape that cleans flat surfaces, such as surface S, and reaches deep into hard-to-get-to corners and crevices as well as clean contoured and transition areas between surfaces. The multi-surface sponge product 10 is designed to clean most surfaces utilizing the side surface 40, which has favorable water absorption characteristics, and the side surface 36 is particularly advantageous in removing build up, such as grout, in hard to reach places, at a jobsite. That is, the foraminous body layer 12, by way of the side surface 40, reaches in and easily wipes up water and the abrasive body layer 20, by way of the side surface 36, provides a heavy-duty aggressive scour surface that removes grout. When appropriate, as shown, the sponge product 10 is wrung to release water D.

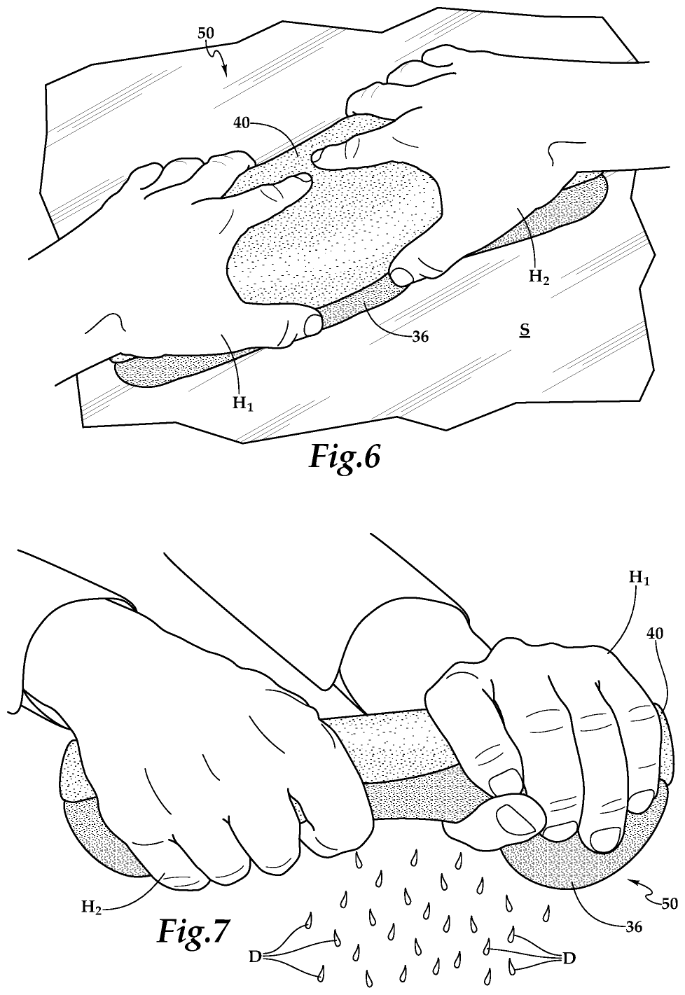

Referring now to FIG. 6 and FIG. 7, as shown, the sponge product 50 includes a dimension sized for two-hand span (hands H₁ and H₂ in FIG. 6) and two-handed wringing (hands H₁ and H₂ in FIG. 7). The sponge product described hereinabove provides the user with a multi-surface sponge product having a low profile shape that cleans flat surfaces, such as surface S, and reaches deep into hard-to-get-to corners and crevices as well as clean contoured and transition areas between surfaces. The multi-surface sponge product 50 is designed to clean most surfaces utilizing the side surface 40, and is particularly advantageous in removing build up, such as grout, in hard to reach places, at a jobsite, with the side surface 36. When appropriate, as shown, the sponge product 50 is wrung to release water D.

Another advantage of the side surface 36, which is adjacent to the abrasive body layer 20, is during the final cleaning process during tile installation, when “holding less water” is useful. By way of explanation, when cleaning following tile installation, the amount of water a cleaning device, like a sponge, holds is directly related to how much water is dispersed on the surface of the tile. It is important to clean the surface with little or minimal disturbance to the softer, uncured material in the joints. Too much water will drag out the uncured material and deposit the uncured material on the surface of the tile. During a final clean, it is often desirable to use less water than during previous stages of the tile installation. For these reasons also, the sponge product 50, as well as the other embodiments of the sponge product 50 presented herein, offer two stages of water retention and control. That is, the sponge product 50, as well as the other embodiments of the sponge product 50 presented herein, include two-water absorption characteristics defined by the side surface 40 proximate to the foraminous body layer 12 having a greater water absorption characteristic than the side surface 36 proximate to the abrasive body layer 20.

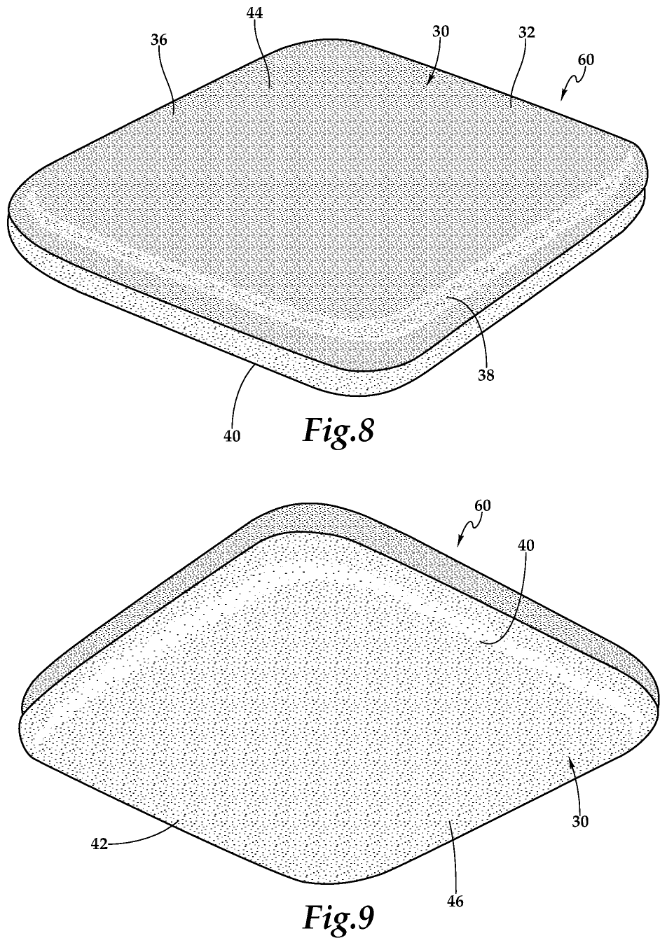

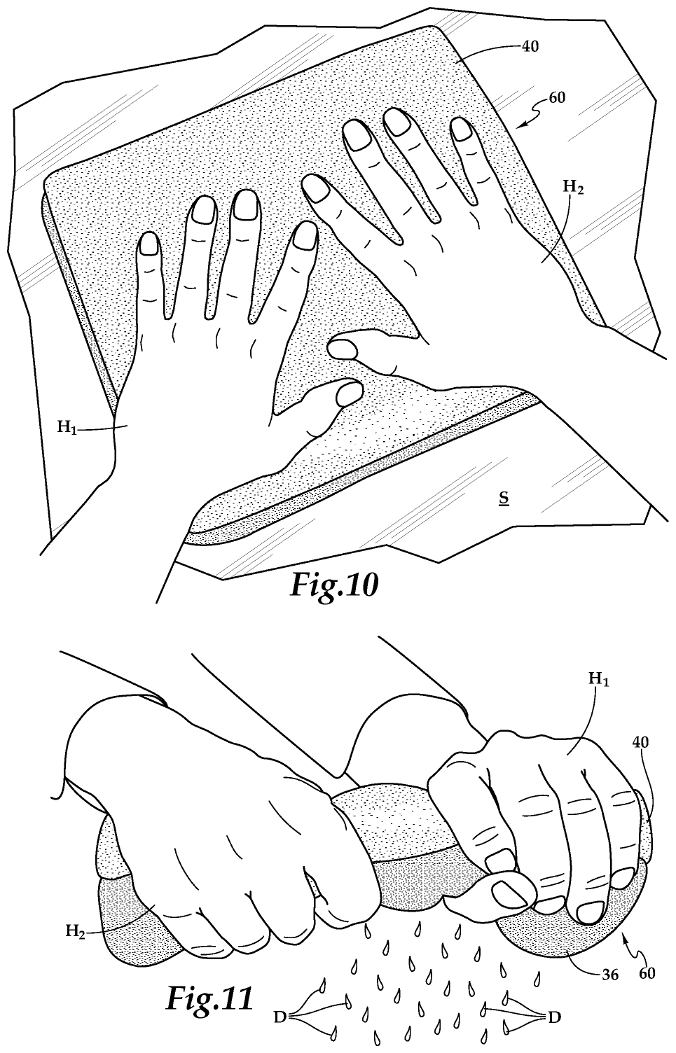

Referring now to FIG. 8 through FIG. 11, as shown, the sponge product 60 includes a dimension sized for two-hand span (hands H₁ and H₂ in FIG. 10) and two-handed wringing (hands H₁ and H₂ in FIG. 11). The sponge product may have dimensions of approximately equal length and width. By way of example and not by way of limitation, the dimensions of the sponge product 60 may be 12 inches (30.5 cm)×12 inches (30.5 cm)×1 inch (2.54 cm) to provide for the placement of two hands during use, like cleaning, and during wringing. Such a two-handed sponge product 60 may cover an area approximately four times larger than the sponge product 10 of FIG. 1, thereby cleaning more area much faster. Also, the large size in terms of length and width mitigates the risks of “balling-up.”

As with other embodiments, the multi-surface sponge product 60 may be designed to clean surfaces utilizing the side surface 40, which has favorable water absorption characteristics. The sponge product 60 is also designed to remove build up, such as grout, in hard to reach places, at a jobsite, with the side surface 36. The side surface 36 may also be utilized to clean surfaces, when less water absorption is required than the side surface 40 offers. When appropriate, as shown, the sponge product 60 is wrung to release water D.

The order of execution or performance of the methods and techniques illustrated and described herein is not essential, unless otherwise specified. That is, elements of the methods and techniques may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A sponge product for cleaning a work surface, the sponge product comprising:
a foraminous body layer having an upper surface, a lower surface, and a sidewall joining the upper surface to the lower surface, the upper surface and the lower surface being located in opposed, parallel spaced relation;
an abrasive body layer having a top surface, a bottom surface, and a side surface joining the top surface and the bottom surface, the top surface and the bottom surface being located in opposed, parallel spaced relation;
the upper surface of the foraminous body layer being attached to the bottom surface of the abrasive body layer;
a microfiber textile having an exterior surface and an interior surface, the interior surface surrounding the foraminous body layer and the abrasive body layer; and
the foraminous body layer, the abrasive body layer, and the microfiber textile forming a unitary product.

2. The sponge product as recited in claim 1, wherein the exterior surface includes a first side with a first visual indicator proximate to the foraminous body layer, the exterior surface including a second side with a second visual indicator proximate the abrasive body layer, the first visual indicator and the second visual indicator being different.

3. The sponge product as recited in claim 2, wherein the first visual indicator further comprises a member selected from the group consisting of colors, numbers, words, and symbols.

4. The sponge product as recited in claim 2, wherein the first visual indicator further comprises a first color and the second visual indicator further comprises a second color.

5. The sponge product as recited in claim 1, wherein the foraminous body layer comprises an open-celled hydrophilic polyurethane foam.

6. The sponge product as recited in claim 5, wherein the open-celled hydrophilic polyurethane foam further comprises a polyester polyol-based polyurethane foam.

7. The sponge product as recited in claim 1, wherein the abrasive body layer further comprises a material selected from the group consisting of polyester fibers, polyethylene fibers, polypropylene fibers, nylon fibers, and reticulated foams.

8. The sponge product as recited in claim 1, wherein the abrasive layer further comprises a non-woven nylon fiber.

9. The sponge product as recited in claim 1, wherein the microfiber textile further comprises a material selected from the group consisting of polyesters, polyamides, and nylon (polyamides).

10. The sponge product as recited in claim 1, wherein the foraminous body layer and the abrasive body layer having different water absorption characteristics.

11. The sponge product as recited in claim 1, wherein the first side proximate to the foraminous body layer has a greater water absorption characteristic than the second side proximate to the abrasive body layer.

12. The sponge product as recited in claim 1, wherein the second side proximate to the abrasive body layer has less of a water absorption characteristic than the first side proximate the foraminous body layer.

13. The sponge product as recited in claim 1, further comprising two-water absorption characteristics defined by the first side proximate to the foraminous body layer having a greater water absorption characteristic than the second side proximate to the abrasive body layer.

14. The sponge product as recited in claim 1, wherein the unitary product further comprises a dimension sized for a two-hand span and a configuration sized for two-handed wringing.

15. The sponge product as recited in claim 14, wherein the unitary product further comprises the dimension of approximately equal length and width.

16. The sponge product as recited in claim 14, wherein the unitary product further comprises the dimension of 12 inches (30.5 cm)×12 inches (30.5 cm)×1 inch (2.54 cm)

17. A sponge product for cleaning a work surface, the sponge product comprising:
a foraminous body layer having an upper surface, a lower surface, and a sidewall joining the upper surface to the lower surface, the upper surface and the lower surface being located in opposed, parallel spaced relation;
an abrasive body layer having a top surface, a bottom surface, and a side surface joining the top surface and the bottom surface, the top surface and the bottom surface being located in opposed, parallel spaced relation;
the foraminous body layer and the abrasive body layer having different water absorption characteristics;
the upper surface of the foraminous body layer being attached to the bottom surface of the abrasive body layer;
a microfiber textile having an exterior surface and an interior surface, the interior surface surrounding the foraminous body layer and the abrasive body layer, the exterior surface having a first side with a first visual indicator proximate to the foraminous body layer, the exterior surface having a second side with a second visual indicator proximate the abrasive body layer, the first visual indicator being a first color and the second visual indicator being a second color; and
the foraminous body layer, the abrasive body layer, and the microfiber textile forming a unitary product.

18. The sponge product as recited in claim 17, wherein the foraminous body layer and the abrasive body layer having different water absorption characteristics.

19. The sponge product as recited in claim 17, further comprising two-water absorption characteristics defined by the first side proximate to the foraminous body layer having a greater water absorption characteristic than the second side proximate to the abrasive body layer.

20. A sponge product for cleaning a work surface, the sponge product comprising:
a foraminous body layer having an upper surface, a lower surface, and a sidewall joining the upper surface to the lower surface, the upper surface and the lower surface being located in opposed, parallel spaced relation;
an abrasive body layer having a top surface, a bottom surface, and a side surface joining the top surface and the bottom surface, the top surface and the bottom surface being located in opposed, parallel spaced relation;
the foraminous body layer and the abrasive body layer having different water absorption characteristics;
the upper surface of the foraminous body layer being attached to the bottom surface of the abrasive body layer;
a microfiber textile having an exterior surface and an interior surface, the interior surface surrounding the foraminous body layer and the abrasive body layer, the exterior surface having a first side with a first visual indicator proximate to the foraminous body layer, the exterior surface having a second side with a second visual indicator proximate the abrasive body layer, the first visual indicator being a first color and the second visual indicator being a second color;
the foraminous body layer, the abrasive body layer, and the microfiber textile forming a unitary product with a first side and a second side, the first side proximate to the foraminous body layer having a greater water absorption characteristic than the second side proximate to the abrasive body layer; and
the unitary product having a dimension sized for a two-hand span and a configuration sized for two-handed wringing.
